(19) United States
(12) Patent Application Publication
(10) Pub. No.: US 2015/0309908 A1
(43) Pub. Date: Oct. 29, 2015

(54) GENERATING AN INTERACTIVE VISUALIZATION OF METRICS COLLECTED FOR FUNCTIONAL ENTITIES

(71) Applicant: HEWLETT-PACKARD DEVELOPMENT COMPANY, L.P., Houston, TX (US)

(72) Inventors: Carol Jean Pearson, Portland, OR (US); Gunnar D. Tapper, Florissant, CO (US); Venkatakrishna Muthuswamy, Cupertino, CA (US); Wei Zhang, Shanghai (CN); Paul E. Denzinger, Aurora, OH (US)

(73) Assignee: HEWLETT-PACKARD DEVELOPMENT COMPANY, L.P., Houston, TX (US)

(21) Appl. No.: 14/264,334

(22) Filed: Apr. 29, 2014

(51) Int. Cl. G06F 11/32; G06F 11/34; G06F 11/30

(52) U.S. Cl. CPC G06F 11/323; G06F 11/3006; G06F 11/3466

(57) ABSTRACT

Data values of metrics for a plurality of functional entities are aggregated, the aggregating producing aggregated values for the respective metrics. A set of the aggregated values is produced for the respective metrics. Based on the set of aggregated values, an interactive visualization of the metrics is generated, the interactive visualization including visual indicators based on the aggregated values for the respective metrics across a plurality of time intervals. The interactive visualization is selectable to focus on a portion of the interactive visualization.

### BACKGROUND

A distributed computing environment can include a large number of nodes, such as computational nodes, storage nodes, and other nodes, which can host hardware components and services provided by machine-readable instructions. As the number of nodes in a distributed computing environment increases, the likelihood of a fault in the distributed computing environment occurring at any given time also increases. A fault in the distributed computing environment can lead to operational failure or performance degradation.

### BRIEF DESCRIPTION OF THE DRAWINGS

Some implementations are described with respect to the following figures.

FIG. 1 is a block diagram of an example arrangement including a distributed computing environment including functional entities and an analytics and visualization system according to some implementations.

FIG. 2 is a flow diagram of an analytics and visualization process according to some implementations.

FIG. 3 is a schematic diagram of a vector of aggregated metric values, according to some implementations.

FIG. 4 is a schematic diagram of an example visualization generated according to some implementations.

FIGS. 5A-5C are graphs displayed in response to selection of a portion of a visualization of aggregated metric values, in accordance with some implementations.

FIG. 6 is a block diagram of an example analytics and visualization system, according to some implementations.

### DETAILED DESCRIPTION

Troubleshooting an issue that occurs in a large distributed computing environment having a distributed arrangement of functional entities can be challenging. The issue may be caused by a failure, fault, or other error at one or multiple functional entities. Examples of functional entities include physical computer nodes, processors, storage devices, communication devices, system processes, application programs, data services, and so forth.

A data service can refer to a subsystem (that includes machine-readable instructions) that provides for storage and management of data. Examples of data services that can be provided include a relational database management service, or a No-SQL (No-Structured Query Language) data management service, and so forth. An instance of a data service running as a single entity across one or more nodes is referred to as a “data service instance.” A No-SQL service provides for storage and processing of data using data structures other than relations (tables) that are used in relational databases. Examples of data structures that can be used to store data by a No-SQL service include trees, graphs, key-value data stores, and so forth. In contrast, a relational database management service stores data in relations, which are accessed using SQL queries.

Examples of issues that can occur in a distributed computing environment can include any of the following: failure or fault of a resource (e.g. a processor, a computer node, a storage device, a communication device, etc.); overloading of a resource; error during execution of a program (including machine-readable instructions), and so forth.

In a large distributed computing environment, there can be several possible causes of any given issue. For example, a delay in delivery of an output by an application program may be due to any of the following: a performance issue of the application program, a fault at one or multiple computer nodes, overloading of a storage device, high traffic in a network, and so forth. To troubleshoot an issue, an analyst may have to access a large amount of data collected over a large time frame to ascertain the cause of the issue, and to understand the scope of the issue. This can be time-consuming and unreliable.

Data of various metrics can be collected for functional entities of a distributed computing environment. A “metric” can refer to any parameter that can provide a measure of an operational characteristic of a functional entity. The metric can be a performance metric and/or a health metric. A performance metric can characterize performance due to utilization of a functional entity is performing. As discussed further below, an example of a performance metric can include pressure on the functional entity. A health metric can provide an indication of a health status (e.g. failed, degraded, normal, etc.) of a functional entity. For example, a failed status can be indicated that a functional entity became non-responsive. A degraded status can be indicated if a functional entity is operating at a level less than a specified threshold. In other examples, instead of provided discrete health status indications, a health score that can vary between a specified range of values can be used for indicating a health of a functional entity.

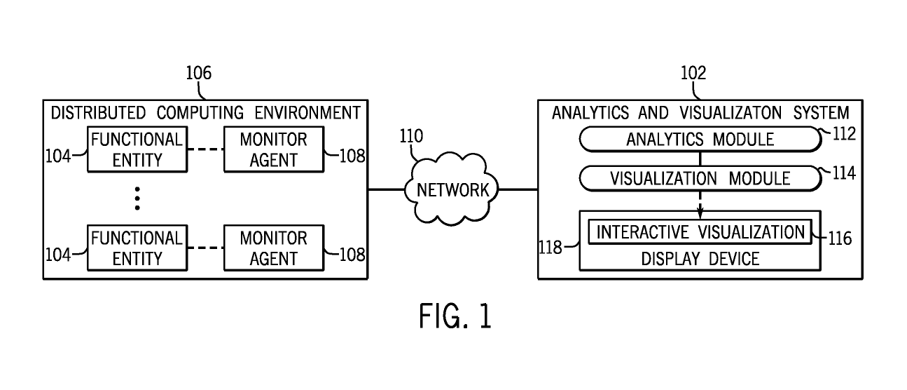

In accordance with some implementations, as shown in FIG. 1, an analytics and visualization system 102 is provided to analyze data of metrics collected for functional entities 104 in a distributed computing environment 106. As shown in FIG. 1, the functional entities 104 are associated with respective monitor agents 108. Each monitor agent 108 can monitor data of metrics associated with the respective functional entity 104. Although one monitor agent 108 is depicted for each corresponding functional entity 104, it is noted that in alternative examples, one monitor agent 108 can be provided for multiple functional entities 104, or alternatively, each functional entity 104 may be associated with multiple monitor agents 108 (such as monitor agents 108 for collecting data for different metrics).

The analytics and visualization system 102 is coupled to the distributed computing environment 106 over a network 110, such as the Internet, a local area network (LAN), a wide area network (WAN), a virtual private network (VPN), and so forth.

Data of metrics collected by the monitor agents 108 for the functional entities 104 can be communicated over the network 110 to the analytics and visualization system 102. The analytics and visualization system 102 includes an analytics module 112 for processing the data of the metrics received from the monitor agents 108. In addition, the analytics and visualization system 102 includes a visualization module 114, which can produce an interactive visualization 116 displayed at a display device 118 based on output data produced by the analytics module 112.

The interactive visualization 116 can be used to graphically depict various metrics. The metrics depicted by the interactive visualization 116 can be derived metrics calculated from metric data received from the monitor agents 108. As examples, the derived metrics can be pressure metrics (which are examples of performance metrics) and/or health metrics. A pressure metric is a calculated measure that is dependent upon usage of a given resource (such as a processing node, a memory, a persistent storage, and a network) as well as a capacity of the given resource. A user can interact with the interactive visualization 116 to focus on a specific portion (e.g. a specific time interval or specific metrics).

The analytics and visualization system 102 can be implemented on one or multiple computer nodes. Each computer node can include a processor or a collection of processors. Also, the analytics and visualization system 102 in some examples can be implemented in a client-server arrangement, where the analytics module 112 and visualization module 114 are executed on one or multiple server computers, and the display device 118 is provided at a client device coupled to the one or multiple server computers.

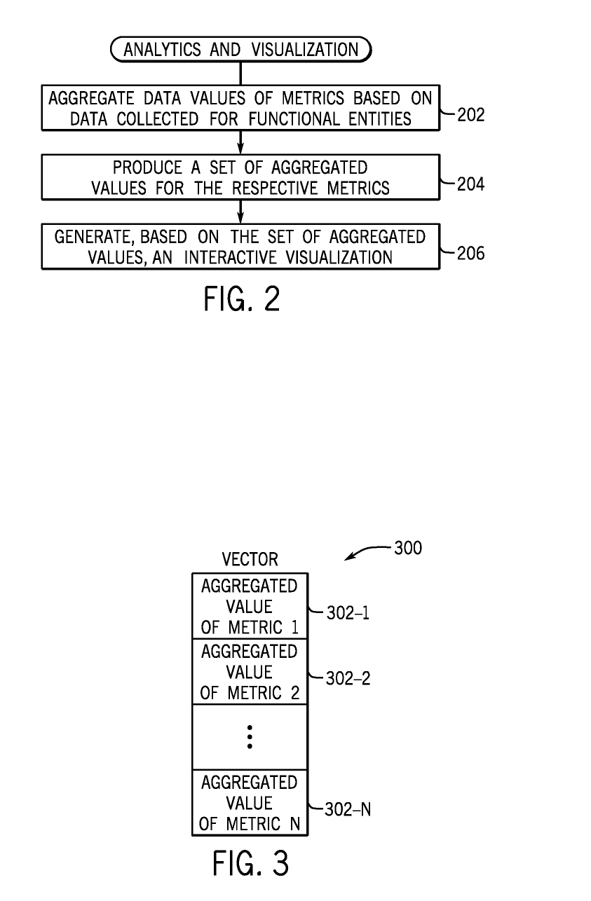

FIG. 2 is a flow diagram of a process that can be performed by the analytics module 112 and the visualization module 114 according to some implementations. The analytics module 112 and the visualization module 114 can be implemented as machine-readable instructions executable in the analytics and visualization system 102. Although depicted as two different modules, it is noted that the analytics module 112 and visualization module 114 can be part of one program, or alternatively, the tasks of the analytics module 112 and visualization module 114 can be performed by multiple programs.

The analytics module 112 aggregates (at 202) data of metrics collected by the monitor agents 108 for the functional entities 104. The aggregating performed by the analytics module 112 produces aggregated values for the respective metrics. As an example, monitor agents 108 can collect data for metrics 1 . . . N (N≧2) for the multiple functional entities 104. Data values of metric i=(i=1 . . . N) collected for multiple respective functional entities 104 can be aggregated into an aggregated value for metric i. The aggregating can include selecting a maximum data value from among the data values of metric i collected for the multiple respective functional entities 104. Alternatively, the aggregating can include computing an average, median, sum, minimum, and so forth, of the data values of metric i.

The analytics module 112 produces (at 204) a set of aggregated values for the respective metrics. The set of the aggregated values can be a vector of the aggregated values. Each entry of the vector corresponds to a respective metric, and this entry includes the aggregated value for the respective metric. An example vector 300 is shown in FIG. 3, which has multiple entries 302-1, 302-2, and 303-N. The entry 302-1 includes the aggregated value of metric 1, the entry 302-2 includes the aggregated value of metric 2, and the entry 302-N includes the aggregated value of metric N.

Data values of the metrics can be correspond to multiple time intervals. As an example, metrics can be collected by the monitor agents 108 at periodic time intervals or intermittent time intervals, or alternatively, in response to specific events. The set of aggregated values produced (at 204) for the respective metrics is for a specific time interval. Multiple sets (e.g. vectors) of aggregated values for the respective metrics can be produced for respective multiple time intervals.

As further shown in FIG. 2, the visualization module 114 generates (at 206), based on the set of aggregated values, an interactive visualization of the metrics. The visualization includes visual indicators (which can be in the form of different colors or other types of visual indicators) that are based on the aggregated values for the respective metrics. In other examples, the visual indicators can be represented as different intensities (e.g. different gray scale levels), as different patterns, and so forth.

The process of FIG. 2 can be iterated for multiple time intervals, which leads to the production of multiple sets of aggregated values for the respective metrics in the corresponding time intervals. The interactive visualization can depict visual indicators for aggregated values of metrics across multiple time intervals, based on respective sets of aggregated values. The interactive visualization is user selectable to focus into a portion (e.g. a subset of the time intervals and/or a subset of metrics) of the interaction visualization that the user deems to be interesting.

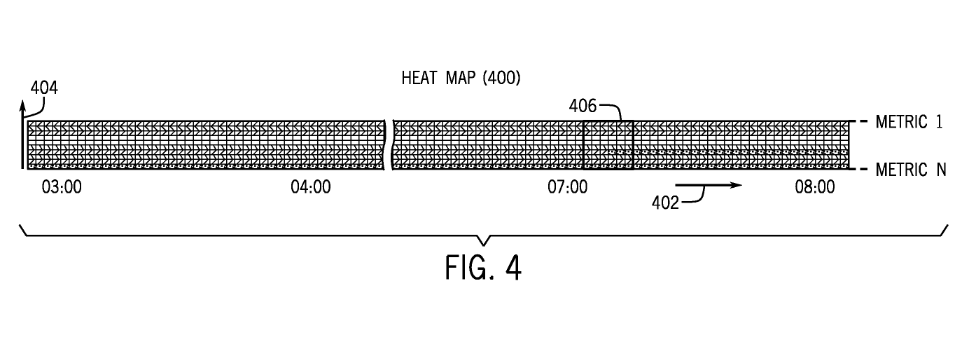

In some examples, the interactive visualization can be in the form of a heat map 400 shown in FIG. 4. The heat map 400 includes a first dimension 402 that corresponds to time. A second dimension 404 of the heat map 400 corresponds to different metrics (metric 1 to metric N in the example of FIG. 4). The heat map 400 includes an arrangement of cells (each cell is represented as a rectangular box in the example of FIG. 4), where a cell represents a value (more specifically, an aggregated value) of a respective metric in a given respective time interval. The cell can be assigned a color based on the aggregated value of the respective metric. In other examples, other types of visual indicators can be assigned based on the aggregated values of each metric.

The heat map 400 includes multiple rows of cells. Each row represents a respective metric. For example, the first row represents metric 1, while the Nth row represents metric N. In each row i (i=1 . . . N), the cells represent aggregated values of metric i at respective different time intervals.

A first subset of metrics 1 to N can include performance metrics, while a second subset of metrics 1 to N can include health metrics. The performance and health metrics can be computed by the analytics module 112, for example. In some examples, red can be used to indicate that a respective value of a performance metric or health metric is indicative of poor performance or poor health. Green can be used to indicate that a respective value of a performance metric or health metric is indicative of good or normal performance or health. Other colors can be used to indicate intermediate performance or health levels. For example, red can indicate unavailability of one or multiple functional entities, yellow can indicate degraded performance or health of one or multiple functional entities, and green can indicate good performance or health of one or multiple functional entities.

Note that each cell in the heat map 400 represents an aggregated value of a metric (in a given time interval) based on metric data collected for multiple functional entities. In some examples, if any of the multiple functional entities is experiencing a degraded performance or health in the given time interval, then the corresponding cell of the heat map 400 can be assigned to a color indicative of poor performance or health, even though other functional entities may be functioning normally (i.e. not experiencing the degraded performance or health).

In some implementations, performance metrics can be pressure metrics, such as processing node pressure, memory pressure, disk pressure, and network pressure, as examples. As noted further above, a pressure metric is a calculated measure that is dependent upon usage of a given resource (such as a processing node, a memory, a persistent storage, and a network) as well as a capacity of the given resource.

Various example pressure metrics are discussed below. It is noted that other examples of pressure metrics can be utilized in other examples.

Memory pressure is computed based on usage of memory and whether such usage causes a data overflow (or data spillover) such that data is swapped between the memory and persistent storage. A persistent storage can be implemented with a disk-based storage (e.g. hard disk drive or optical disk drive) or solid state storage (e.g. flash memory device). A memory can be implemented with a higher speed memory device such as a dynamic random access memory (DRAM) device, a static random access memory (SRAM), or other type of memory device.

A data overflow (or data spillover) occurs when there is no more available space in a memory, such that some data has to be moved from the memory to a persistent storage to accommodate new data. As an example, 100% usage of a memory may not be indicative of poor performance, so long as there is no excessive swapping of data between the memory and the persistent storage. Swapping data between the memory and persistent storage can slow down performance since reading data from and/or writing data to the persistent storage can be time consuming, due to the slower access speed of the persistent storage as compared to the access speed of the memory. Memory pressure can thus be calculated based on a memory usage measure (e.g. percentage of memory used) and a measure indicating the amount of swapping between the memory and persistent storage. A higher memory pressure is indicated if there is higher memory usage and the swapping measure indicates a higher amount of swapping between memory and persistent storage.

Persistent storage pressure can be based on a persistent storage usage measure (which indicates the amount of usage of the persistent storage, such as a number of input/output (I/O) cycles to the persistent storage) and a bandwidth measure that indicates the amount (e.g. percentage or an absolute or relative value) of the bandwidth between the persistent storage and a computer node (or processor) that has been consumed. A higher persistent storage pressure is indicated if there is a higher number of I/O cycles and the bandwidth measure indicates a higher consumption of the bandwidth between the persistent storage and the computer node (or processor).

Network pressure can be calculated based on a measure of an amount of usage of the network and a measure indicating an overall capacity of the network.

Processing node pressure refers to pressure of a processor or of a computer node. The processing node pressure considers both a load measure indicating a load on the processing node, as well as a run-queue depth that includes a number of processes running or waiting to execute on the processing node. Assuming that the processing node is a computer node that has multiple processors, there can be a process run queue for each processor of the computer node, if certain process classes are restricted to individual processors. In a specific example, the number of processes on a run queue per processor (which can be represented as a LoadQueue measure) can be computed by dividing the number of processes running or waiting to run (in the run queue) by the number of processes available for running those processes. A parameter FullQueueUtilization can define a maximum acceptable ratio of waiting and running processes to a number of processors, which can be represented as NumProcessors. The LoadQueue measure is then compared to the parameter FullQueueUtilization to determine the processing node utilization pressure. In some examples, a normalized LoadQueue measure can be computed by dividing the LoadQueue measure by the number of processors, to produce a NormalizedLoadQueue metric, which can be a normalized percentage value between 0% and 100%.

In an example of the heat map 400, four of the rows can be used to represent the processing node pressure, memory pressure, persistent storage pressure, and network pressure, respectively. In other examples, the heat map 400 can depict other types of performance metrics.

As noted above, the heat map 400 can also depict health metrics. In some examples, health of the distributed computing environment 106 is calculated for respective different layers, such that rows in the heat map 400 can represent a health metric for respective different layers.

In some examples, the different layers can include a storage layer, a server layer, an operating system layer, a data service infrastructure layer, a data service layer, and a data service connectivity layer. Although specific example layers are listed above, it is noted that in other examples, health metrics can be calculated for other types of layers.

Health in the storage layer corresponds to the health of storage devices and/or storage servers or controllers in the distributed computing environment 106. Health at the server layer corresponds to health of computer nodes in the distributed computing environment 106. Health at the operating system layer corresponds to health relating to activities of operating systems in the distributed computing environment 106.

Health of the data service infrastructure layer relates to health of the infrastructure used for implementing a data service, such as a relational database management service, a No-SQL data service, and so forth. Health at the data service layer relates to health relating to execution of a data service application (e.g. relational database management application, No-SQL application). Health relating to the data service connectivity layer relates to health of connectivity to a data service, where the connectivity is used to exchange messages with the data service.

The health metric of each of the layers can be a metric that is based on a response time of a functional entity in the respective layer, a number of errors experienced by the functional entity in the respective layer, a number of functional entities that are down, synchronization (such as time clock synchronization) among functional entities, or on some other value.

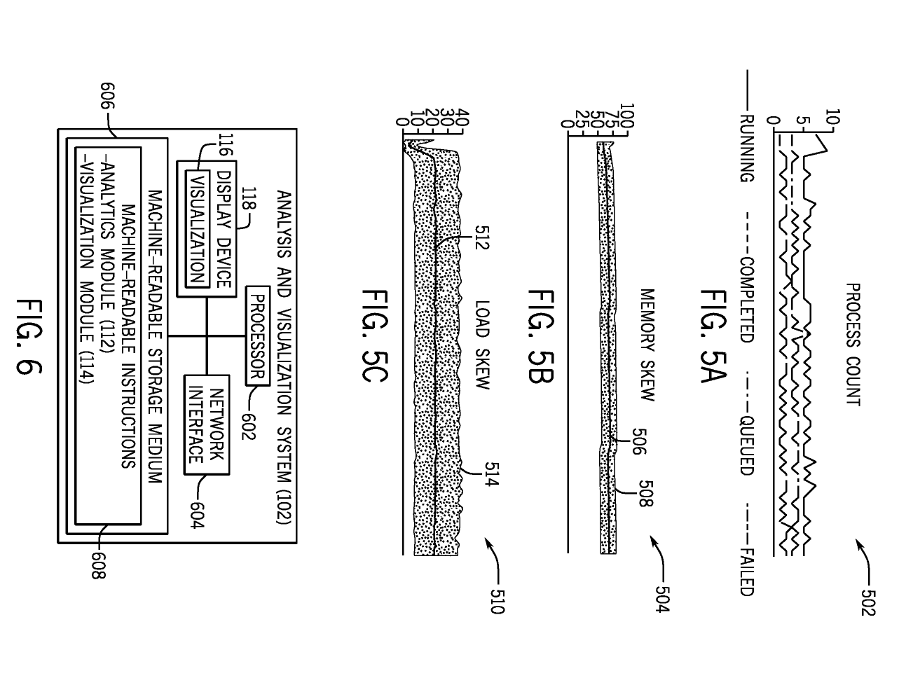

The heat map 400 is an interactive heat map that allows for user selection of a portion of the heat map 400. For example, in FIG. 4, a user has selected a region 406 around a portion of the heat map 400. This selection may be performed by performing a rubber band operation around the region 406 using a user input device, such as a mouse device or a touchscreen. In response to the user selection of the region 406 in the heat map 400, additional graphs as shown in FIGS. 5A-5C can be generated and displayed. Although specific graphs are shown in the examples of FIGS. 5A-5C, it is noted that in other implementations, other example graphs can be generated and displayed.

Graph 502 shown in FIG. 5A depicts a count of the processes running or waiting to run in the time interval corresponding to the selected region 406. Different curves of the graph 502 can represent the following, respectively: a count of running processes, a count of completed processes, a count of queued processes, and a count of failed processes.

Graph 504 in FIG. 5B shows memory skew in the time interval corresponding to the selected region 406. Memory skew can indicate that a particular computer node is experiencing significantly more or significantly less memory pressure than most other nodes on which a data service instance runs, so that memory usage is widely uneven across the set of computer nodes associated with the data service instance. Memory skew can indicate a performance issue. The graph 504 includes a curve 506 that represents the average memory skew, and a band 508 around the curve 506 that represents a range of memory skews.

Graph 510 in FIG. 5C shows load skew in the time interval corresponding to the selected region 406. Load skew can indicate that a particular computer node is experiencing significantly more or significantly less computer processing pressure than other nodes on which a data service instance runs, so that the run queue depths vary widely across the set of computer nodes associated with the data service instance. Load skew can indicate a performance issue. The graph 510 includes a curve 512 that represents the average memory skew, and a band 514 around the curve 512 that represents a range of memory skews.

More generally, for a data service instance, resource consumption is expected to be consistently level across all computer nodes of a particular class. “Skew” is present when one or more nodes use significantly more or less of a resource than other nodes, so that consumption is unbalanced. Skew can be experienced by users in the form of delayed or missing results, for example.

The various metrics depicted in FIGS. 5A-5C are further analytics data that can be computed by the analytics module 112 based on metric data collected by the monitor agents 108 of FIG. 1.

By calculating performance and/or health metrics, and visualizing such metrics in a visualization, such as the heat map 400 of FIG. 4, a user can easily perform visual pattern detection to identify a portion (e.g. selected region 406 in FIG. 4) that may be indicative of an issue (or issues) that should be investigated further. The user can select on the portion of the visualization, to cause additional information (e.g. graphs 502, 504, and 510 of FIGS. 5A-5C) to be displayed.

FIG. 6 is a block diagram of the analytics and visualization system 102 according to some implementations. The analytics and visualization system 102 includes one or multiple processors 602, which can be in a computer or multiple computers. A processor can include a microprocessor, microcontroller, processor module or subsystem, programmable integrated circuit, programmable gate array, or another control or computing device. The analytics and visualization system 102 includes a network interface 604, for communicating over a network such as network 110 in FIG. 1.

In addition, the analytics and visualization system 102 includes a non-transitory machine-readable or computer-readable storage medium (or storage media) 606, which can store machine-readable instructions 608 for the analytics module 112 and the visualization module 114. The analytics module 112 and visualization module 114 can be loaded for execution on the processor(s) 602.

In addition, the analytics and visualization system 102 includes the display device 118 used for displaying the interactive visualization 116, which can be in the form of the heat map 400 shown in FIG. 4, for example.

The storage medium (or storage media) can be implemented as one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
aggregating, by a system including a processor, data values of metrics based on data collected for a plurality of functional entities, the aggregating producing aggregated values for the respective metrics;
producing, by the system, a set of the aggregated values for the respective metrics; and
generating, by the system based on the set of aggregated values, an interactive visualization of the metrics, the interactive visualization including visual indicators based on the aggregated values for the respective metrics across a plurality of time intervals, wherein the interactive visualization is selectable to focus on a portion of the interactive visualization.

2. The method of claim 1, further comprising assigning different visual indicators to cells in the visualization based on the corresponding aggregated values, wherein each of the cells represents a respective one of the metrics in a respective one of the time intervals.

3. The method of claim 1, wherein the visual indicators include different colors, the method further comprising assigning colors to cells in the visualization based on the corresponding aggregated values, wherein each of the cells represents a respective one of the metrics in a respective one of the time intervals.

4. The method of claim 1, wherein the aggregating comprises aggregating data values of a given one of the metrics, to produce an aggregated value for the given metric, wherein different ones of the data values correspond to respective different functional entities.

5. The method of claim 4, wherein aggregating the data values of the given metric comprises selecting a maximum of the data values of the given metric.

6. The method of claim 1, wherein a first of the metrics includes a performance metric that represents performance of the plurality of functional entities, and a second of the metrics includes a health metric that represents a health of the plurality of functional entities.

7. The method of claim 1, wherein the performance metric is a pressure metric that is dependent upon usage of a resource and a capacity of the resource.

8. The method of claim 1, wherein generating the interactive visualization comprises generating the interactive visualization that depicts health metrics for a plurality of layers.

9. The method of claim 8, wherein the plurality of layers include at least two from among a storage layer, a server layer, an operating system layer, a data service infrastructure layer, a data service layer, and a data service connectivity layer.

10. The method of claim 1, further comprising:
receiving a user selection of a portion of the interactive visualization; and
in response to the user selection, generating analytics data produced by performing analytics on data of the metrics associated with the selected portion.

11. A system comprising:
at least one processor to:
aggregate data values of metrics for a plurality of functional entities, the aggregating producing aggregated values for the respective metrics;
insert the aggregated data values into a vector of aggregated values for the respective metrics;
generate, based on the vector of aggregated values, an interactive visualization of the metrics, the interactive visualization including cells representing the respective aggregated values for corresponding time intervals; and
in response to user selection of a portion of the interactive visualization, generate further information relating to a time interval of the selected portion.

12. The system of claim 11, wherein the further information include a plurality of graphs depicting further metrics based on metric data collected for the plurality of functional entities.

13. The system of claim 11, wherein the metrics include a pressure metric and a health metric, the pressure metric being is dependent upon usage of a resource and a capacity of the resource, and the health metric indicating a health of the system.

14. The system of claim 13, wherein the pressure metric is selected from among a processing node pressure, a memory pressure, a persistent storage pressure, and a network pressure, and the health metric is for a layer of the system, the layer selected from multiple layers of the system.

15. An article comprising at least one non-transitory machine-readable storage medium storing instructions that upon execution cause a system to:
aggregate data values of metrics for a plurality of functional entities, the aggregating producing aggregated values for the respective metrics, the metrics including a pressure metric and a health metric, the pressure metric being is dependent upon usage of a resource and a capacity of the resource, and the health metric indicating a health of a layer in the system;
produce a set of the aggregated values for the respective metrics; and
generate, based on the set of aggregated values, an interactive visualization of the metrics, the interactive visualization including cells representing the respective aggregated values for corresponding time intervals, the interactive visualization is selectable to focus on a portion of the interactive visualization; and
assign different visual indicators to the cells based on the aggregated values in the set.
